(19) United States
(12) Patent Application Publication
(10) Pub. No.: US 2024/0360920 A1
(43) Pub. Date: Oct. 31, 2024

(54) SOUND QUALITY EVALUATION METHOD AND SOUND QUALITY EVALUATION DEVICE FOR WASTEGATE VALVE

(71) Applicant: MITSUBISHI HEAVY INDUSTRIES ENGINE & TURBOCHARGER, LTD., Sagamihara-shi, Kanagawa (JP)

(72) Inventor: Tomoaki TAKESHITA, Tokyo (JP)

(73) Assignee: MITSUBISHI HEAVY INDUSTRIES ENGINE & TURBOCHARGER, LTD., Sagamihara-shi, Kanagawa (JP)

(21) Appl. No.: 18/573,820

(22) PCT Filed: Sep. 8, 2021
(86) PCT No.: PCT/JP2021/033036

§ 371 Date: Dec. 22, 2023

(51) Int. Cl. F16K 37/00; F02B 37/18

(52) U.S. Cl. CPC F16K 37/0083; F02B 37/183

(57) ABSTRACT

This sound quality evaluation method for a wastegate valve comprises: a vibration data acquisition step for acquiring a plurality of pieces of vibration data that indicate vibration occurring in a wastegate valve and that are in a prescribed time period during which the degree of openness of the wastegate valve changes; a POA data acquisition step for acquiring POA values at a prescribed frequency band of 0.5 kHz or greater from a plurality of frequency spectra attained by performing frequency analysis on each of the plurality of pieces of vibration data; and a vibration noise evaluation step for evaluating vibration noise occurring in the wastegate valve on the basis of the plurality of POA values.

### TECHNICAL FIELD

The present disclosure relates to a sound quality evaluation method and a sound quality evaluation device for a wastegate valve.

### BACKGROUND ART

In the related art, a wastegate valve provided in a turbocharger is known. A flow rate of an exhaust gas flowing into a turbine of a turbocharger from an engine is adjusted by the wastegate valve. For example, the wastegate valve disclosed in PTL 1 is fixed to a drive shaft via a lever. When the drive shaft is rotated, a valve body forming the wastegate valve opens and closes a wastegate flow path.

### CITATION LIST

### Patent Literature

[PTL 1] International Publication No. WO2015/097786

### SUMMARY OF INVENTION

### Technical Problem

For example, due to vibration of a driving engine, at least one component forming the wastegate valve may intermittently vibrate within a range of a clearance formed around the wastegate valve, and a vibration noise may be generated. It is difficult to analyze and predict an intermittent vibration phenomenon of the component by performing a simulation. Therefore, in order to determine whether the wastegate valve has a proper structure which does not generate an abnormal vibration noise, the related art has to rely on a sensory evaluation in which sound quality of an actually generated vibration noise is evaluated based on human hearing.

An object of the present disclosure is to provide a sound quality evaluation method and a sound quality evaluation device for a wastegate valve, which can quantitatively evaluate sound quality of a vibration noise.

### Solution to Problem

According to at least one embodiment of the present disclosure, there is provided a sound quality evaluation method for a wastegate valve.

The sound quality evaluation method for a wastegate valve includes a vibration data acquisition step of acquiring a plurality of pieces of vibration data in a predetermined time period during which an opening degree of the wastegate valve varies, the vibration data indicating vibration generated in the wastegate valve, a POA data acquisition step of acquiring each POA value in a predetermined frequency band of 0.5 kHz or higher from each of a plurality of frequency spectra obtained by performing a frequency analysis on each of the plurality of pieces of vibration data, and a vibration noise evaluation step of evaluating a vibration noise generated in the wastegate valve, based on a plurality of the POA values.

According to at least one embodiment of the present disclosure, there is provided a sound quality evaluation device for a wastegate valve.

The sound quality evaluation device for a wastegate valve includes a vibration data acquisition unit that acquires a plurality of pieces of vibration data in a predetermined time period during which an opening degree of the wastegate valve varies, the vibration data indicating vibration generated in the wastegate valve, a POA data acquisition unit that acquires each POA value in a predetermined frequency band of 0.5 kHz or higher from each of a plurality of frequency spectra obtained by performing a frequency analysis on each of the plurality of pieces of vibration data, and a vibration noise evaluation unit that evaluates a vibration noise generated in the wastegate valve, based on a plurality of the POA values.

### Advantageous Effects of Invention

According to the present disclosure, it is possible to provide a sound quality evaluation method and a sound quality evaluation device for a wastegate valve which can quantitatively evaluate sound quality of a vibration noise.

### BRIEF DESCRIPTION OF DRAWINGS

FIG. 1 is a view conceptually illustrating a sound quality evaluation device for a wastegate valve according to an embodiment of the present disclosure.

FIG. 2 is a view conceptually illustrating vibration data acquired by a vibration data acquisition unit according to the embodiment of the present disclosure.

FIG. 3 is a view conceptually illustrating a POA value acquired by a POA data acquisition unit according to the embodiment of the present disclosure.

FIG. 4 is a graph conceptually illustrating a comparison result between a POA value when an abnormal vibration noise is generated and a POA value when the abnormal vibration noise is not generated.

FIG. 5 is a view conceptually illustrating a ratio acquired by a ratio acquisition unit according to the embodiment of the present disclosure.

FIG. 6 is a view conceptually illustrating a detailed configuration of a vibration noise evaluation unit according to the embodiment of the present disclosure.

FIG. 7 is a view conceptually illustrating a multiplication value acquired by a multiplication value acquisition unit according to the embodiment of the present disclosure.

FIG. 8 is a graph illustrating a relationship between a total sum acquired by a total sum acquisition unit and a sensory evaluation according to the embodiment of the present disclosure.

FIG. 9 is a flowchart illustrating a method for evaluating sound quality of a vibration noise of a wastegate valve according to the embodiment of the present disclosure.

FIG. 10 is a flowchart illustrating a sound quality evaluation method based on a POA value of the vibration data according to the embodiment of the present disclosure.

### DESCRIPTION OF EMBODIMENTS

Hereinafter, some embodiments of the present disclosure will be described with reference to the accompanying drawings. However, dimensions, materials, shapes, and relative dispositions of components described as the embodiments or illustrated in the drawings are not intended to limit the scope of the present disclosure, and are merely examples for describing the present disclosure.

For example, expressions representing relative or absolute dispositions such as “in a certain direction”, “along a certain direction”, “parallel”, “orthogonal”, “center”, “concentric”, or “coaxial” not only strictly represent the dispositions, but also represent a state where the dispositions are relatively displaced with a tolerance or at an angle or a distance to such an extent that the same function can be obtained.

For example, expressions representing that things are in an equal state such as “same”, “equal”, and “homogeneous” not only strictly represent an equal state, but also represent a state where a difference exists with a tolerance or to such an extent that the same function can be obtained.

For example, expressions representing shapes such as a quadrangular shape and a cylindrical shape not only represent shapes such as the quadrangular shape and the cylindrical shape in a geometrically strict sense, but also represent shapes including an uneven portion or a chamfered portion within a range where the same effect can be obtained.

Meanwhile, expressions of “being provided with”, “including”, or “having” one component are not exclusive expressions excluding existence of other components.

The same reference numerals may be assigned to the same configurations, and description thereof may be omitted.

### Outline of Sound Quality Evaluation System 10

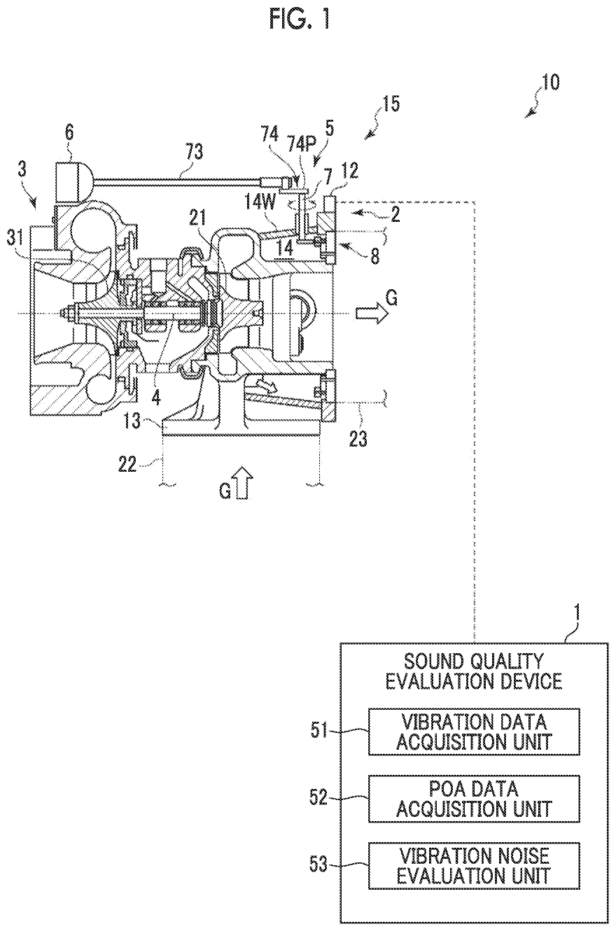

FIG. 1 is a view conceptually illustrating a sound quality evaluation device for a wastegate valve according to an embodiment of the present disclosure. In the illustrated embodiment, a sound quality evaluation device 1 for a wastegate valve (hereinafter, may be simply referred to as a “sound quality evaluation device 1” in some cases) is incorporated in a sound quality evaluation system 10. The sound quality evaluation system 10 includes an engine (not illustrated) and a turbocharger 15 in addition to the sound quality evaluation device 1. Hereinafter, each component of the sound quality evaluation system 10 will be described.

### Outline of Configuration of Turbocharger 15

FIG. 1 schematically illustrates a sectional view of the turbocharger 15. The turbocharger 15 includes a gas inlet portion 13 into which an exhaust gas G discharged from the engine flows, an exhaust turbine 2 rotated by the exhaust gas G flowing into the engine, a compressor 3 driven by the exhaust turbine 2 to compress intake air of the engine, a wastegate valve 5 for opening and closing a wastegate flow path 14 bypassing the exhaust turbine 2, and an actuator 6 for driving the wastegate valve 5.

The gas inlet portion 13 communicates with an upstream side exhaust flow path 22 through which the exhaust gas G of the engine flows. In addition, a turbine wheel 21 is accommodated inside the exhaust turbine 2, and a compressor wheel 31 is accommodated inside the compressor 3. The turbine wheel 21, the compressor wheel 31, and a rotary shaft 4 connecting the turbine wheel 21 and the compressor wheel 31 form a rotating body which is rotationally driven by the exhaust gas G. The exhaust gas G passing through the turbine wheel 21 and the exhaust gas G flowing through the wastegate flow path 14 after bypassing the turbine wheel 21 can flow to a downstream side exhaust flow path 23.

### Configuration of Wastegate Valve 5 and Actuator 6

In the illustrated embodiment, the wastegate valve 5 is connected to the actuator 6 via a rod 73 and a link mechanism 74. As an example, the actuator 6 is an electric actuator in which the rod 73 linearly reciprocates.

The wastegate valve 5 includes a shaft 7 rotatably held by a wall portion 14W defining the wastegate flow path 14 via a bush (not illustrated), and a valve 8 provided in one end (lower end in an example in FIG. 1) of the shaft 7. The other end of the shaft 7 is connected to a link plate 74P forming the link mechanism 74. Therefore, a driving force of the actuator 6 is transmitted to the shaft 7 via the rod 73 and the link mechanism 74. In this manner, the shaft 7 rotates around an axial direction, and the valve 8 opens and closes the wastegate flow path 14. An opening degree of the wastegate flow path 14 (that is, an opening degree of the wastegate valve 5) is adjusted by controlling the actuator 6. The control for the actuator 6 is performed in accordance with an elapsed time from when the engine starts, a rotation speed of the engine, a change rate of the rotation speed of the engine, or a combination thereof.

Clearances are respectively formed between the shaft 7 and a bush (not illustrated) and between the shaft 7 and the link plate 74P. Therefore, when vibration caused by driving the engine is transmitted to the wastegate valve 5, the shaft 7 may intermittently vibrate in some cases. According to the knowledge of the inventor, the vibration tends to be particularly generated in a time period during which the opening degree of the wastegate valve 5 varies. When the vibrating shaft 7 collides with at least one of the bush or the link plate 74P, a vibration noise may be generated in the wastegate valve 5. This case is only one example of reasons for the vibration noise generated in the wastegate valve 5. Apart from this reason (or together with this reason), the vibration noise may be generated in the wastegate valve 5 due to other reasons. For example, even when the other end of the shaft 7 is connected to the link plate 74P via another member, another vibrating member may collide with the link plate 74P to generate the vibration noise. Alternatively, when the wastegate valve 5 has a predetermined opening degree, for example, the vibrating valve 8 may collide with the wall portion 14W defining the wastegate flow path 14, and the vibration noise may be generated.

### Outline of Configuration of Sound Quality Evaluation Device 1

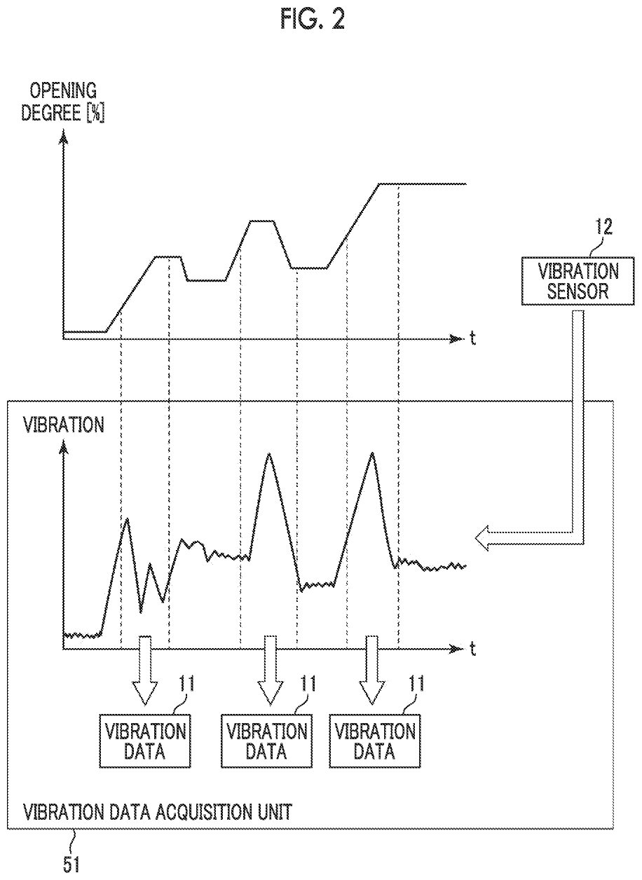

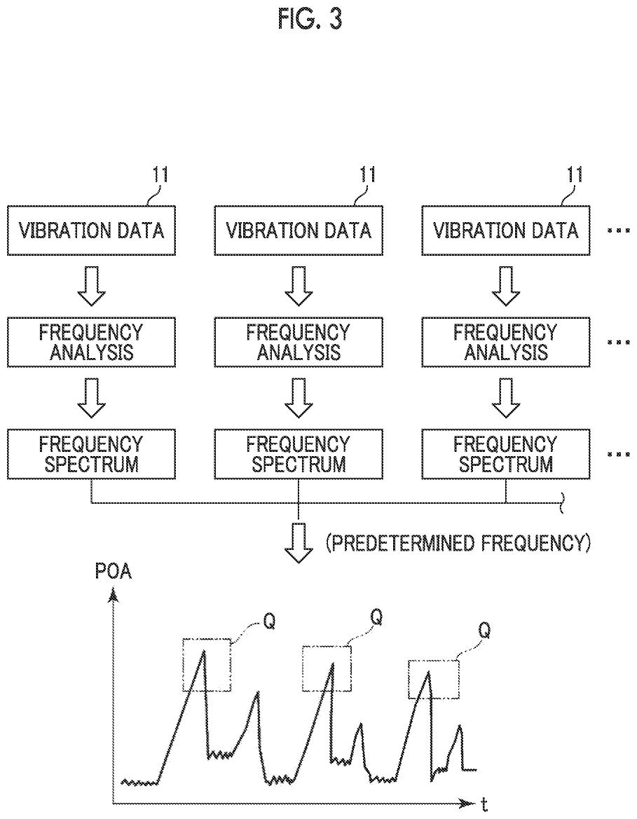

A configuration of the sound quality evaluation device 1 will be described with reference to FIGS. 1 to 3. FIG. 2 is a view conceptually illustrating vibration data acquired by a vibration data acquisition unit according to the embodiment of the present disclosure. FIG. 3 is a view conceptually illustrating a POA value acquired by the POA data acquisition unit according to the embodiment of the present disclosure. FIG. 4 is a graph conceptually illustrating a comparison result between a POA value when an abnormal vibration noise is generated and a POA value when the abnormal vibration noise is not generated.

The sound quality evaluation device 1 is configured to quantitatively evaluate sound quality of the vibration noise generated by the wastegate valve 5. As an example, the sound quality evaluation device 1 is realized by one or a plurality of arithmetic devices including a processor and a memory. The processor is a CPU, a GPU, an MPU, a DSP, or a combination thereof. Alternatively, the processor may be realized by an integrated circuit such as a PLD, an ASIC, an FPGA, or an MCU. The memory electrically connected to the processor temporarily or non-temporarily stores data to be processed by the processor. The memory is realized by a ROM, a RAM, a flash memory, or a combination thereof.

The sound quality evaluation device 1 according to the embodiment includes a vibration data acquisition unit 51, a POA data acquisition unit 52, and a vibration noise evaluation unit 53.

In the embodiment illustrated in FIGS. 1 and 2, the vibration data acquisition unit 51 is configured to acquire a plurality of pieces of vibration data 11 indicating vibration generated in the wastegate valve 5. Here, an upper side graph in FIG. 2 illustrates a time-dependent change in an opening degree of the wastegate valve 5, and a lower side graph in FIG. 2 illustrates a time-dependent change in vibration of the wastegate valve 5 at the same time. Each of the plurality of pieces of vibration data 11 indicates the vibration in a predetermined time period. The predetermined time period includes a time period during which the opening degree of the wastegate valve 5 varies. As a more specific example, the opening degree of the wastegate valve 5 may vary from beginning to end over the predetermined time period, or may vary only temporarily in the predetermined time period. In addition, the predetermined time periods respectively corresponding to the plurality of pieces of vibration data 11 acquired by the vibration data acquisition unit 51 may be time periods which do not overlap each other at all, or may be time periods which partially overlap each other (in an example in FIG. 2, the predetermined time periods do not overlap each other at all).

The vibration data acquisition unit 51 is configured to acquire the plurality of pieces of vibration data 11, based on a detection result of a vibration sensor 12 for detecting the vibration generated in the wastegate valve 5. The vibration sensor 12 in FIG. 1 is a merely conceptually illustrated example, and the vibration sensor 12 may be disposed at any position as long as the vibration of the wastegate valve 5 can be detected. For example, the vibration sensor 12 may be provided in the shaft 7, the valve 8, the link mechanism 74, the actuator 6, the wall portion 14W defining the wastegate flow path 14, or a component of the turbocharger 15. The vibration sensor 12 is an accelerometer as an example, but may be a microphone in another example.

The vibration data acquisition unit 51 acquires data in which the vibration and a time are associated with each other, based on the detection result of the vibration sensor 12. The data corresponds to the lower side graph conceptually illustrated in FIG. 2. Then, from this data, the data corresponding to each of a plurality of predetermined time periods is extracted as the vibration data 11.

In the embodiment illustrated in FIGS. 1 and 3, the POA data acquisition unit 52 is configured to acquire each partial overall (POA) value in a predetermined frequency band, from each of a plurality of frequency spectra obtained by performing a frequency analysis on each of the plurality of pieces of vibration data 11 acquired by the vibration data acquisition unit 51. The frequency analysis is FFT, BPF, or simple Fourier transform. The frequency analysis in this example is a Short-Term Fourier Transform (STFT). The predetermined frequency is a frequency band of 0.5 kHz or higher. Since 0.5 kHz is a value sufficiently greater than a frequency corresponding to a general rotation speed of the engine, influence of the vibration of the engine is unlikely to appear as a noise in the acquired POA value. The predetermined frequency is more preferably 1 to 5 kHz, and is even more preferably 2 to 5 kHz. The graph conceptually illustrated in FIG. 3 illustrates a time-dependent change in the POA value acquired by the POA data acquisition unit 52.

The vibration noise evaluation unit 53 is configured to evaluate the vibration noise generated in the wastegate valve 5, based on a plurality of POA values acquired by the POA data acquisition unit 52. As illustrated in FIG. 4, according to the knowledge of the inventor, when a POA value of the wastegate valve 5 (non-qualified product) determined to generate the abnormal vibration noise (hereinafter, may be referred to as an abnormal noise) by performing a sensory evaluation based on hearing is compared with a POA value of the wastegate valve 5 (qualified product) determined not to generate the abnormal vibration noise, tendencies of peak values are different from each other. In this regard, a difference in identifiable tendencies appears. In this manner, the vibration noise evaluation unit 53 can evaluate the vibration noise generated in the wastegate valve 5.

According to the above-described configuration, the vibration data acquisition unit 51 acquires the plurality of pieces of vibration data 11 in a predetermined time period during which the opening degree varies in the wastegate valve 5 which has a strong tendency to generate the abnormal noise. Then, each of the plurality of pieces of vibration data 11 is subjected to the frequency analysis, and the plurality of POA values in a predetermined frequency band of 0.5 kHz or higher are acquired from each of the plurality of frequency spectra by the POA data acquisition unit 52. Since 0.5 kHz is sufficiently higher than a frequency corresponding to the rotation speed of the engine provided with the wastegate valve 5, the POA value which is less affected by the vibration of the engine is acquired. In addition, according to the knowledge of the inventor, the POA values serving as evaluation targets of the vibration noise evaluation unit 53 correlate with the sound quality of the vibration noise generated in the wastegate valve 5. Therefore, the wastegate valve sound quality evaluation device 1 which can quantitatively evaluate the sound quality is realized.

### Details of POA Value Acquired by POA Data Acquisition Unit 52

As conceptually illustrated in FIG. 3, the POA value acquired by the POA data acquisition unit 52 forms at least a portion of a graph in which a horizontal axis represents a time and a vertical axis represents the POA value. The POA data acquisition unit 52 acquires the POA value for a time period excluding a time at which the opening degrees of the wastegate valve 5 are 0% and 100%. The POA value corresponding to the above-described time period is the POA value surrounded by a two-point chain line Q in FIG. 2. According to the knowledge of the inventor, when the opening degree of the wastegate valve 5 is 0% or 100%, there is a low probability that the abnormal noise will be generated in the wastegate valve 5. According to the above-described configuration, the acquired POA value greatly varies depending on whether the sound quality of the vibration noise generated in the wastegate valve 5 is good or bad. Therefore, it is possible to accurately evaluate whether or not the abnormal vibration noise is generated in the wastegate valve 5.

Furthermore, it is more preferable that the opening degree of the wastegate valve 5 is 25% to 62.5% in the time period surrounded by the two-point chain line Q. That is, it is more preferable that the POA data acquisition unit 52 acquires the POA value for a time period during which the opening degree of the wastegate valve 5 is 25% to 62.5%. According to the knowledge of the inventor, there is a higher probability that the abnormal noise is generated in the wastegate valve 5 when the opening degree of the wastegate valve 5 is 25% to 62.5%. According to the above-described configuration, it is possible to more accurately evaluate whether or not the abnormal vibration noise is generated in the wastegate valve 5 for the reasons described above.

### Outline of Evaluation Method Used by Vibration Noise Evaluation Unit 53

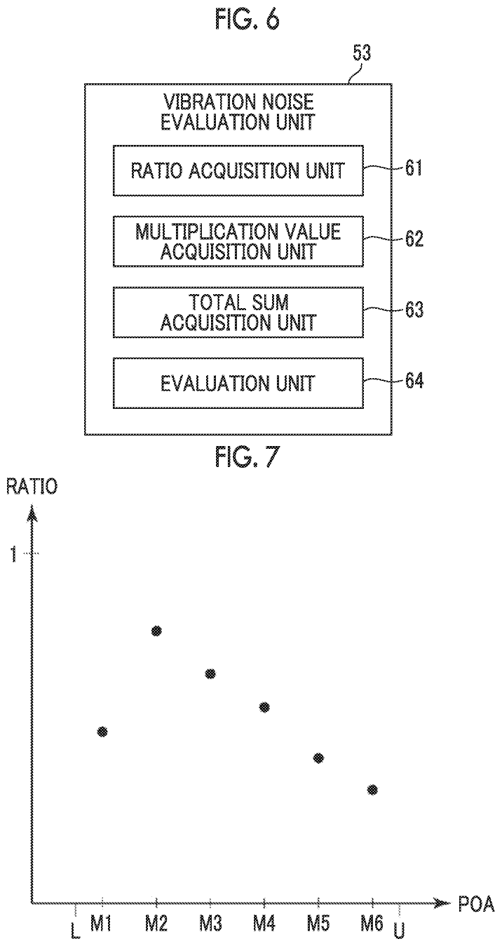

The vibration noise evaluation unit 53 illustrated in FIG. 1 is configured to evaluate the vibration noise, based on a value obtained by performing statistical processing on the plurality of POA values acquired by the vibration data acquisition unit 51. For example, it is possible to evaluate the sound quality of the vibration noise by comparing the value subjected to the statistical processing with a threshold value. The statistical processing may be statistical processing (to be described later with reference to FIGS. 6 and 7), or may be processing for calculating an average value of the plurality of acquired POA values. According to the above-described configuration, even when the plurality of POA values acquired by the POA data acquisition unit 52 have mutual variations, the statistical processing is performed on the POA values. Therefore, it is possible to accurately evaluate the sound quality of the vibration noise generated in the wastegate valve 5.

### Range of POA Value Acquired by POA Data Acquisition Unit 52

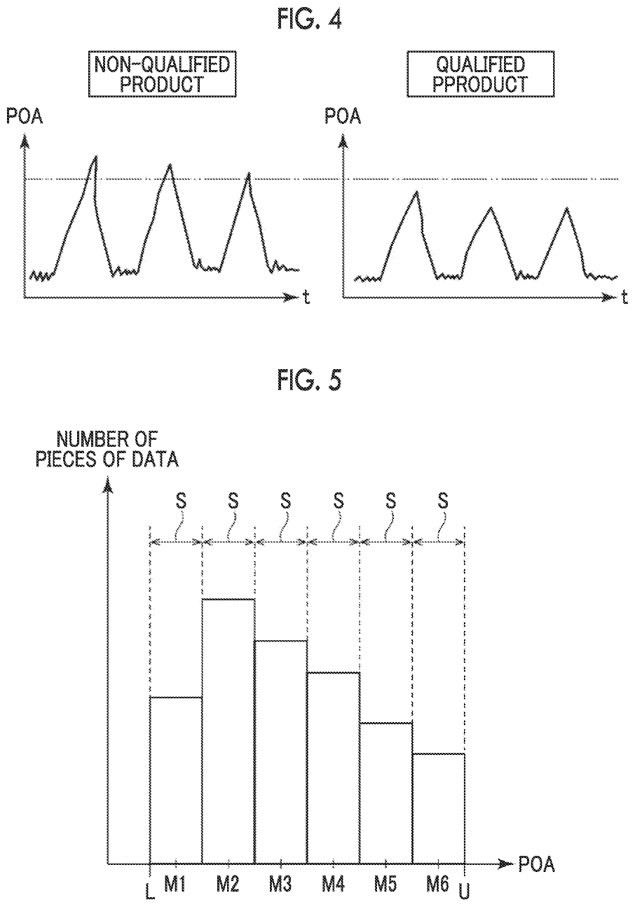

FIG. 5 is a view conceptually illustrating a distribution of the number of the POA values acquired by the POA data acquisition unit 52. The number of the POA values (that is, a total number of pieces of data) acquired by the POA data acquisition unit 52 can be conceptually indicated by a histogram as illustrated in FIG. 5. A range of the plurality of POA values acquired by the POA data acquisition unit 52 (that is, a range in which the values can be acquired) is indicated by a lower limit value L and an upper limit value U. In FIG. 5, a plurality of sections S obtained by equally dividing the above-described range from the lower limit value L to the upper limit value U are conceptually illustrated. The total number of the POA values in each of the sections S corresponds to the total number of the POA values acquired by the POA data acquisition unit 52. As will be described later, an evaluation result obtained by the vibration noise evaluation unit 53 (to be described later) varies depending on the number of the POA values included in each of the sections S.

### Example of Details of Evaluation Method Used by Vibration Noise Evaluation Unit 53

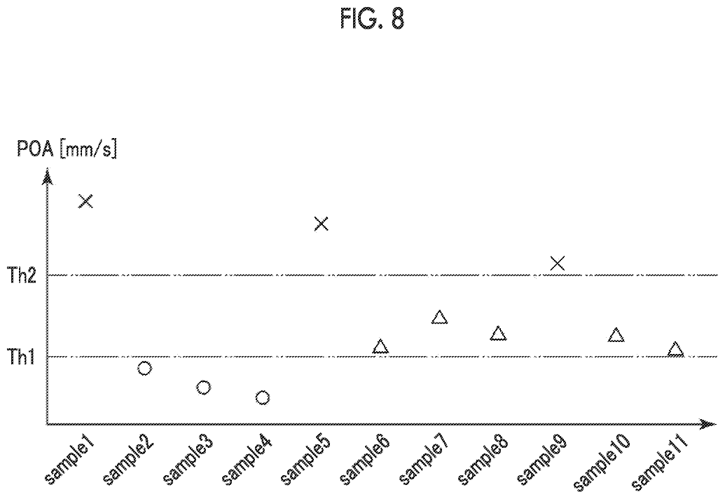

An example of details of an evaluation method used by the vibration noise evaluation unit 53 will be described with reference to FIGS. 6 to 8. FIG. 6 is a view conceptually illustrating a detailed configuration of the vibration noise evaluation unit according to the embodiment of the present disclosure. FIG. 7 is a view conceptually illustrating a ratio acquired by a ratio acquisition unit according to the embodiment of the present disclosure. FIG. 8 is a graph illustrating a relationship between a total sum acquired by a total sum acquisition unit and a sensory evaluation according to the embodiment of the present disclosure.

In the embodiment illustrated in FIG. 6, the vibration noise evaluation unit 53 includes a ratio acquisition unit 61, a multiplication value acquisition unit 62, a total sum acquisition unit 63, and an evaluation unit 64.

The ratio acquisition unit 61 is configured to acquire a ratio (proportion) of the number of the POA values included in the section S to the total number of the plurality of acquired POA values, for each of the plurality of sections S (refer to FIG. 5). The ratio acquired by the ratio acquisition unit 61 can be conceptually illustrated in the graph in FIG. 7. It can be understood that each ratio acquired by the ratio acquisition unit 61 for each of the plurality of sections S indicates a probability that any POA value acquired by the POA data acquisition unit 52 is included in the section S. The total sum of the ratios indicated by six plot points illustrated in FIG. 7 is 1.

For each of the plurality of sections S, the multiplication value acquisition unit 62 is configured to acquire a multiplication value obtained by multiplying a representative value of the section S and the ratio in the section S for each of the plurality of sections S. In FIG. 7, the representative values of each section S are illustrated as M1 to M6 (the same applies to FIG. 5). For example, the representative value is a median value of each section S.

The total sum acquisition unit 63 is configured to acquire the total sum of the respective multiplication values acquired for each section S. It can be understood that the total sum is a value obtained by performing the statistical processing on the plurality of acquired POA values, and more specifically, it can be understood that the total sum indicates an expected value of the POA value acquired by the POA data acquisition unit 52. The graph illustrated in FIG. 8 indicates a relationship between the total sum acquired by the total sum acquisition unit 63, based on the vibration data 11 of the wastegate valve 5, and a result obtained by performing a sensory evaluation on the vibration noise of the wastegate valve 5 when acquiring the vibration data 11, based on human hearing. In this verification, 11 wastegate valves 5 are prepared as samples. In the graph in FIG. 8, a result of determining that there is no abnormal noise by performing the sensory evaluation is “o”, a result of determining that there is the abnormal noise is “x”, and an intermediate result between the two is “Δ”.

As can be understood from FIG. 8, as the total sum acquired by the total sum acquisition unit 63 becomes greater, a result of the sensory evaluation becomes worse. That is, it can be understood that there is a correlation between the total sum acquired by the total sum acquisition unit 63 and the result of the sensory evaluation. Therefore, when the total sum acquired by the total sum acquisition unit 63 is used, the vibration noise generated in the wastegate valve 5 can be evaluated without relying on the sensory evaluation.

The evaluation unit 64 illustrated in FIG. 6 is configured to evaluate the sound quality of the vibration noise generated in the wastegate valve 5, based on the total sum acquired by the total sum acquisition unit 63. For example, a threshold value Th1 that can be a boundary between “o” and “Δ” illustrated in FIG. 8 and a threshold value Th2 that can be a boundary between “Δ” and “x” are set. The evaluation unit 64 evaluates that the abnormal noise is generated in the wastegate valve 5 in which the total sum acquired by the total sum acquisition unit 63 is greater than the threshold value Th2. In addition, the evaluation unit 64 evaluates that the abnormal noise is not generated in the wastegate valve 5 in which the acquired total sum is smaller than the threshold value Th1. According to the above-described configuration, the sound quality of the vibration noise generated in the wastegate valve 5 can be accurately evaluated without relying on the sensory evaluation.

In another embodiment, the threshold value used by the evaluation unit 64 during the evaluation may be one instead of two, or may be three or more. In addition, it is not essential that the evaluation unit 64 uses the threshold value. For example, when the total sums acquired by the total sum acquisition unit 63 for each of the plurality of wastegate valves 5 are compared with each other, the sound quality can be relatively evaluated without using the threshold value.

### Flowchart of Sound Quality Evaluation Method

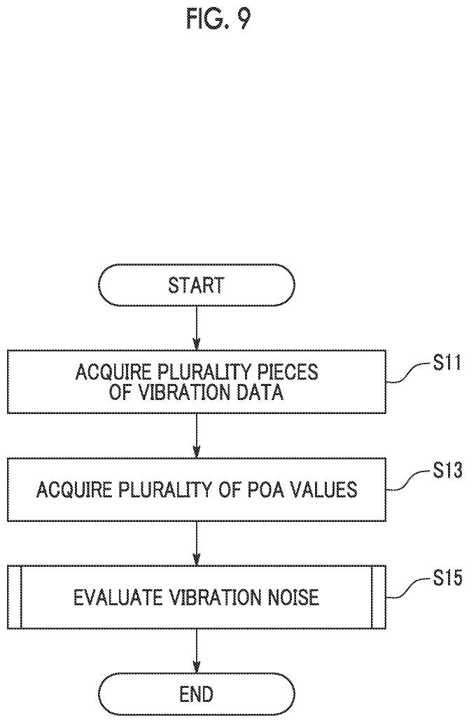

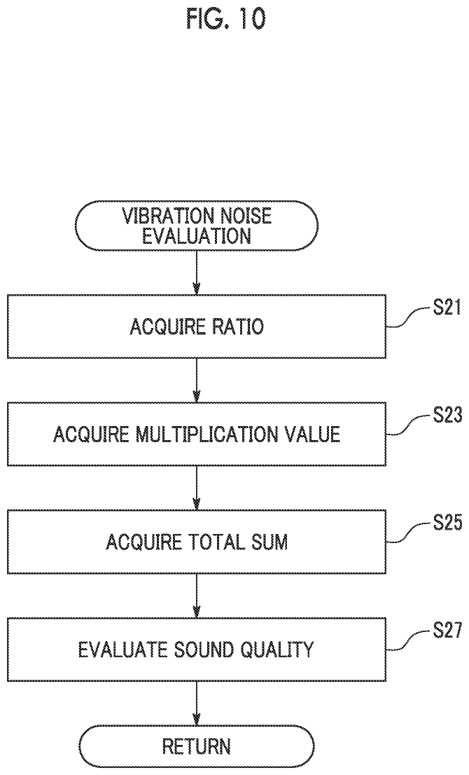

FIG. 9 is a flowchart illustrating a sound quality evaluation method for the vibration noise of the wastegate valve according to the embodiment of the present disclosure. FIG. 10 is a flowchart illustrating the sound quality evaluation method based on the POA value of vibration data according to the embodiment of the present disclosure. In the following, a “step” may be abbreviated as “S”.

First, for example, the plurality of pieces of vibration data 11 indicating the vibration generated in the wastegate valve 5 as the engine is driven are acquired (S11). S11 is performed by the vibration data acquisition unit 51 described above. Subsequently, the plurality of POA values are acquired (S13). S13 is performed by the POA data acquisition unit 52 described above. Subsequently, the vibration noise generated in the wastegate valve 5 is evaluated, based on the plurality of POA values acquired in S13 (S15). S15 is performed by the vibration noise evaluation unit 53 described above.

A method for evaluating the vibration noise performed in S15 will be described. First, for each of the plurality of sections S (see FIG. 5) described above, the ratio of the number of POA values included in the section S to the total number of the plurality of POA values acquired in S13 is acquired (S21). S21 is performed by the ratio acquisition unit 61 described above. Subsequently, a multiplication value obtained by multiplying the representative value of the section S and the ratio of the section S is acquired for each of the plurality of sections S (S23). S23 is performed by the multiplication value acquisition unit 62 described above. Subsequently, the total sum of the multiplication values acquired in S23 is acquired (S25). S25 is performed by the total sum acquisition unit 63 described above. Finally, the sound quality of the vibration noise is evaluated, based on the total sum acquired in S25 (S27). S27 is performed by the evaluation unit 64 described above. Through the above-described steps, the evaluation of the vibration noise of the wastegate valve 5 is performed.

In another embodiment, in S11, instead of driving the engine, for example, an exciter may apply an exciting force to the turbocharger 15. Even in this case, the vibration data 11 of the vibration generated in the wastegate valve 5 can be acquired. That is, when the vibration is transmitted to the wastegate valve 5 which has some structural problems, the abnormal noise is generated, and the total sum acquired in S25 also becomes a greater value. In addition, at least a portion of the steps forming the flowchart may be performed by a person, instead of being performed by the sound quality evaluation device 1 including the processor. For example, at least either S25 or S27 may be performed by a person.

### Summary

Contents described in some of the above-described embodiments are understood as follows, for example.

1) According to at least one embodiment of the present disclosure, there is provided the sound quality evaluation method for the wastegate valve including the vibration data acquisition step (S11) of acquiring the plurality of pieces of vibration data (11) in a predetermined time period during which the opening degree of the wastegate valve (5) varies, the vibration data (11) indicating the vibration generated in the wastegate valve (5), the POA data acquisition step (S13) of acquiring each POA value in a predetermined frequency band of 0.5 kHz or higher from each of the plurality of frequency spectra obtained by performing the frequency analysis on each of the plurality of pieces of vibration data (11), and the vibration noise evaluation step (S15) of evaluating the vibration noise generated in the wastegate valve (5), based on the plurality of the POA values.

According to the configuration of 1) above, in the vibration data acquisition step (S11), a plurality of pieces of vibration data (11) are acquired in a predetermined time period during which the opening degree varies in the wastegate valve (5) which has a strong tendency to generate the abnormal noise. Then, in the POA data acquisition step (S13), each of the plurality of pieces of vibration data (11) is subjected to the frequency analysis, and the plurality of POA values in a predetermined frequency band of 0.5 kHz or higher are acquired from each of the plurality of frequency spectra. Since 0.5 kHz is sufficiently higher than a frequency corresponding to the rotation speed of the engine provided with the wastegate valve (5), the POA value which is less affected by the vibration of the engine is acquired. In addition, according to the knowledge of the inventor, the POA values serving as evaluation targets in the vibration noise evaluation step (S15) correlate with the sound quality of the vibration noise generated in the wastegate valve (5). Therefore, the sound quality evaluation method for the wastegate valve which can quantitatively evaluate the sound quality of the vibration noise is realized.

2) In some embodiments, in the sound quality evaluation method for the wastegate valve according to 1) above, in the POA data acquisition step (S13), the POA value for a time period excluding a time at which the opening degree of the wastegate valve (5) is 0% and a time at which the opening degree is 100% is acquired.

According to the knowledge of the inventor, when the opening degree of the wastegate valve (5) is 0% or 100%, there is a low probability that the abnormal noise will be generated in the wastegate valve (5). According to the configuration of 2) above, the acquired POA value greatly varies depending on whether the sound quality of the vibration noise generated by the wastegate valve (5) is good or bad. Therefore, it is possible to accurately evaluate whether or not the abnormal vibration noise is generated in the wastegate valve (5).

3) In some embodiments, in the sound quality evaluation method for the wastegate valve according to 2) above, in the POA data acquisition step (S13), the POA value for a time period during which the opening degree of the wastegate valve (5) is 25% to 62.5% is acquired.

According to the knowledge of the inventor, when the opening degree of the wastegate valve (5) is 25% to 62.5%, there is a higher possibility that the abnormal noise may be generated in the wastegate valve (5). According to the configuration of 3) above, it is possible to more accurately evaluate whether or not the abnormal vibration noise is generated in the wastegate valve (5) for the same reason as in 2) above.

4) In some embodiments, in the sound quality evaluation method for the wastegate valve according to any one of 1) to 3) above, in the vibration noise evaluation step (S15), the vibration noise is evaluated, based on the value obtained by performing the statistical processing on the plurality of POA values.

According to the configuration of 4) above, even when the plurality of POA values acquired in the POA data acquisition step (S13) have mutual variations, the statistical processing is performed on the POA values. Therefore, it is possible to accurately evaluate the sound quality of the vibration noise generated in the wastegate valve 5).

5) In some embodiments, in the sound quality evaluation method for the wastegate valve according to 4) above, the vibration noise evaluation step (S15) includes the ratio acquisition step (S21) of acquiring the ratio of the number of the POA values included in the section to the total number of the plurality of POA values acquired in the POA value acquisition step, for each of the plurality of sections obtained by equally dividing the range from the lower limit value to the upper limit value, the multiplication value acquisition step (S23) of acquiring the multiplication value obtained by multiplying the representative value of the section and the ratio in the section, for each of the plurality of sections, the total sum acquisition step (S25) of acquiring the total sum of the acquired respective multiplication values, and the evaluation step (S27) of evaluating the vibration noise, based on the acquired total sum.

The total sum, which is the value acquired in the total sum acquisition step (S25) and obtained by performing the statistical processing, has a correlation with the sound quality of the noise generated by the wastegate valve (5). Therefore, according to the configuration of 5) above, the sound quality of the vibration noise generated by the wastegate valve (5) can be accurately evaluated without relying on the sensory evaluation based on human hearing.

6) According to at least one embodiment of the present disclosure, there is provided the sound quality evaluation device (1) for the wastegate valve, the sound quality evaluation device (1) for the wastegate valve includes the vibration data acquisition unit (51) for acquiring the plurality of pieces of vibration data (11) in a predetermined time period during which the opening degree of the wastegate valve (5) varies, the vibration data (11) indicating the vibration generated in the wastegate valve (5), the POA data acquisition unit (52) for acquiring each POA value in a predetermined frequency band of 0.5 kHz or higher from each of a plurality of frequency spectra obtained by performing the frequency analysis on each of the plurality of pieces of vibration data (11), and the vibration noise evaluation unit (53) for evaluating the vibration noise generated in the wastegate valve (5), based on a plurality of the POA values.

According to the configuration of 6) above, the sound quality evaluation device (1) for the wastegate valve which can quantitatively evaluate the sound quality of the vibration noise is realized for the same reason as in 1) above.

### Reference Signs List

1: Sound quality evaluation device
5: Wastegate valve
8: Valve
11: Vibration data
51: Vibration data acquisition unit
52: POA data acquisition unit
53: Vibration noise evaluation unit
64: Evaluation unit
L: Lower limit value
S: Section
U: Upper limit value

1. A sound quality evaluation method for a wastegate valve, comprising:
a vibration data acquisition step of acquiring a plurality of pieces of vibration data in a predetermined time period during which an opening degree of the wastegate valve varies, the vibration data indicating vibration generated in the wastegate valve;
a POA data acquisition step of acquiring each POA value in a predetermined frequency band of 0.5 kHz or higher from each of a plurality of frequency spectra obtained by performing a frequency analysis on each of the plurality of pieces of vibration data; and
a vibration noise evaluation step of evaluating a vibration noise generated in the wastegate valve, based on a plurality of the POA values.

2. The sound quality evaluation method for a wastegate valve according to claim 1,
wherein in the POA data acquisition step, the POA value for a time period excluding a time at which the opening degree of the wastegate valve is 0% and a time at which the opening degree of the wastegate valve is 100% is acquired.

3. The sound quality evaluation method for a wastegate valve according to claim 2,
wherein in the POA data acquisition step, the POA value for a time period during which the opening degree of the wastegate valve is 25% to 62.5% is acquired.

4. The sound quality evaluation method for a wastegate valve according to claim 1,
wherein in the vibration noise evaluation step, the vibration noise is evaluated, based on a value obtained by performing statistical processing on the plurality of POA values.

5. The sound quality evaluation method for a wastegate valve according to claim 4,
wherein the vibration noise evaluation step includes
for each of a plurality of sections obtained by equally dividing a range from a lower limit value to an upper limit value, a ratio acquisition step of acquiring a ratio of the number of the POA values included in the section to a total number of the plurality of POA values acquired in the POA data acquisition step,
a multiplication value acquisition step of acquiring a multiplication value obtained by multiplying a representative value of the section and the ratio in the section, for each of the plurality of sections,
a total sum acquisition step of acquiring a total sum of the acquired respective multiplication values, and
an evaluation step of evaluating the vibration noise, based on the acquired total sum.

6. A sound quality evaluation device for a wastegate valve, comprising:
a vibration data acquisition unit for acquiring a plurality of pieces of vibration data in a predetermined time period during which an opening degree of the wastegate valve varies, the vibration data indicating vibration generated in the wastegate valve;
a POA data acquisition unit for acquiring each POA value in a predetermined frequency band of 0.5 kHz or higher from each of a plurality of frequency spectra obtained by performing a frequency analysis on each of the plurality of pieces of vibration data; and
a vibration noise evaluation unit for evaluating a vibration noise generated in the wastegate valve, based on a plurality of the POA values.
